(19) United States
(12) Patent Application Publication
(10) Pub. No.: US 2013/0060393 A1
(43) Pub. Date: Mar. 7, 2013

(54) HOME AND BUSINESS DEVICE ENERGY CONSUMPTION TRIPPER

(71) Applicants: Poothabalan Somasundaram, Tirunelveli (IN); Thamilenthi Palanivelu, Chennai (IN); Ganesh Ramasamy, Chennai (IN); Arunkumar Surulinathan, Theni District (IN); Krishnakumar Sundaram, Erode (IN)

(72) Inventors: Poothabalan Somasundaram, Tirunelveli (IN); Thamilenthi Palanivelu, Chennai (IN); Ganesh Ramasamy, Chennai (IN); Arunkumar Surulinathan, Theni District (IN); Krishnakumar Sundaram, Erode (IN)

(73) Assignee: VERIZON PATENT AND LICENSING INC., Basking Ridge, NJ (US)

(21) Appl. No.: 13/225,618

(22) Filed: Sep. 6, 2011

(51) Int. Cl. G06F 1/26

(52) U.S. Cl. 700/291

(57) ABSTRACT

An energy management device receives a first user-specified energy consumption limit associated with a first device, and receives a second user-specified energy consumption limit associated with a second device. The energy management device receives a first energy consumption report associated with the first device, and receives a second energy consumption report associated with the second device. The energy management device selectively switches off, or performs a graduated reduction of power consumption of, the first or second devices based on the received first and second energy consumption reports. The first and second devices include appliances resident in a household or business and the energy management device connects to each of the first and second devices via a network or link.

### BACKGROUND

Household or business appliances, such as, for example, computers, televisions, lighting systems, air conditioning systems, heating systems, etc., consume various amounts of energy depending on the usage of the appliances. For example, a thermostat for an air conditioning system may be set to cool a household or business to a certain temperature, and the air conditioning system may consume an amount of energy related to how often the air conditioning system is active to cool the household or business to the certain temperature. As another example, a computer may consume an amount of energy based on how long the computer is turned on.

### BRIEF DESCRIPTION OF THE DRAWINGS

FIG. 1 is a diagram that illustrates an overview of the control of the energy consumption of multiple devices located in a household or business by an energy management device;

FIG. 2 illustrates an exemplary network environment in which energy management devices resident at households or businesses may operate to monitor the energy consumed by devices at the households or businesses;

FIG. 3 is a diagram that depicts an example of a household/business of FIG. 2, and the communication of energy consumption reports from devices to the energy management device of the household/business;

FIG. 4 depicts examples of energy consumption monitoring circuits that may used to measure energy consumption at a device of FIG. 1;

FIG. 5 is a diagram that depicts exemplary components of the energy management device of FIGS. 1 and 2;

FIG. 6 is a flow diagram that illustrates an exemplary process for providing user-specified per-device energy consumption limits to the energy management device for use in controlling the energy consumption patterns of the devices of FIG. 1;

FIG. 7 is an exemplary messaging diagram associated with the exemplary process of FIG. 6;

FIG. 8 is an exemplary user interface that may be used in conjunction with the exemplary process of FIG. 7;

FIG. 9 is a flow diagram that illustrates an exemplary process for controlling a power down state of the devices of FIG. 1 based on energy consumption reports received from the devices and based further on user-specified energy consumption limits;

FIG. 10 is an exemplary messaging diagram associated with the exemplary process of FIG. 9; and

FIG. 11 is an exemplary user interface that may be used in conjunction with the exemplary process of FIG. 9.

### DETAILED DESCRIPTION OF THE PREFERRED EMBODIMENTS

The following detailed description refers to the accompanying drawings. The same reference numbers in different drawings may identify the same or similar elements. The following detailed description does not limit the invention.

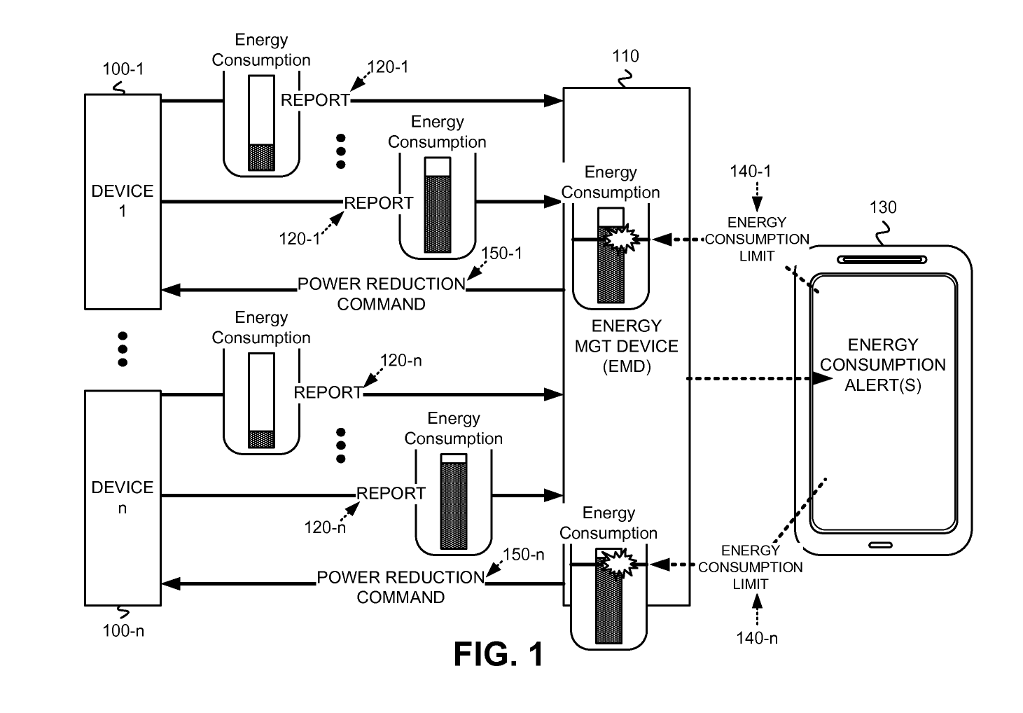

FIG. 1 illustrates an overview of the control of the energy consumption of multiple devices 100-1 through 100-n located in a household or business by an energy management device (EMD) 110. Each of devices 100-1 through 100-n (generically referred to herein as “device 100”) may send energy consumption reports to energy management device 110 via, for example, a network or a link (e.g., a wired or wireless link). Each device 100 may include an appliance resident in a household or a business that may connect to energy management device 110 via a network or a link. Device 100 may include any type of household or business appliance including, for example, an air conditioning or heating system, a computer, a television, a lighting system, etc. Energy management device 110 may reside in the household or business and monitor the energy consumption reports from devices 100-1 through 100-n for controlling the amount of energy that one or more of devices 100-1 through 100-n consume. Energy management device 110 may include, for example, a telephone; a laptop, desktop, palmtop or tablet computer; a personal digital assistant (PDA), or other type of digital computing device that may communicate with devices 100-1 through 100-n via a link or network.

As depicted in FIG. 1, a client device 130 may be used by a user (not shown) to specify an energy consumption limit for each device 100. The energy consumption limit may include a maximum energy usage and/or usage rate for a selected device over a period of time (e.g., day, week, month), a maximum total energy usage for the selected device over the period of time, and/or a maximum global energy usage rate or total energy usage over the period of time for all devices 100-1 through 100-n in a given household or business. For example, the user may specify an energy consumption limit that includes a maximum energy usage rate of 3 kilowatt (kWh) for an air conditioning system. As another example, the user may specify an energy consumption limit that includes a maximum total energy usage of 10,000 W at any given time or a maximum rate of 10 kWh for a given household. Client device 130 may include, for example, a cellular telephone (e.g., a smart phone); a laptop, desktop, palmtop or tablet computer; a personal digital assistant (PDA), or other type of digital computing device that may communicate with energy management device 110. Client device 130 may include functionality (e.g., a software application) for interacting with energy management device 110 to set energy consumption limits of devices 100-1 through 100-n.

As further shown in FIG. 1, device 100-1 may send energy consumption reports 120-1 to energy management device 110, and device 100-n may also send energy consumption reports 120-n to energy management device 110. The energy consumption reports may be sent periodically, or at the occurrence of specific events (e.g., when an energy consumption limit is exceeded). The energy consumption reports may include data specifying the current energy consumed by the device, and/or data indicating that user-specified energy consumption limits have been exceeded. Upon receipt of the energy consumption report, energy management device 110 may compare the energy consumption reports with the previously received user-specified per-device energy consumption limits 140-1 through 140-n, to identify energy consumption that exceeds energy consumption limits 140-1 through 140-n. Upon determining that device energy consumption patterns exceed the energy consumption limits, energy management device 110 may itself display messages detailing energy consumption alerts, and/or send messages containing energy consumption alerts to client device 130. Upon receipt, the energy consumption alerts may be displayed at client device 130.

Energy management device 110, based on a determination that device energy consumption patterns exceed the energy consumption limits, may send respective power reduction commands 150-1 through 150-n to devices 100-1 through 100-n. For example, as shown in FIG. 1, energy management device 110 may determine, based on energy consumption reports 120-1 from device 100-1, that device 100-1's energy consumption exceeds energy consumption limit 140-1. Consequently, energy management device 110 may send a power reduction command 150-1 to device 100-1 to either turn device 100-1 off, or to perform a graduated turn down of device 100-1. For example, if device 100-1 includes a computer, then power reduction command 150-1 may instruct the computer to completely power down, or to enter a reduced power “sleep” mode. As another example, if device 100-1 includes an air conditioning system, then power reduction command 150-1 may instruct the air conditioning system to raise the set point temperature (e.g., from 72 degrees Fahrenheit to 78 degrees Fahrenheit), thus, resulting in graduated turn down of the air conditioning system.

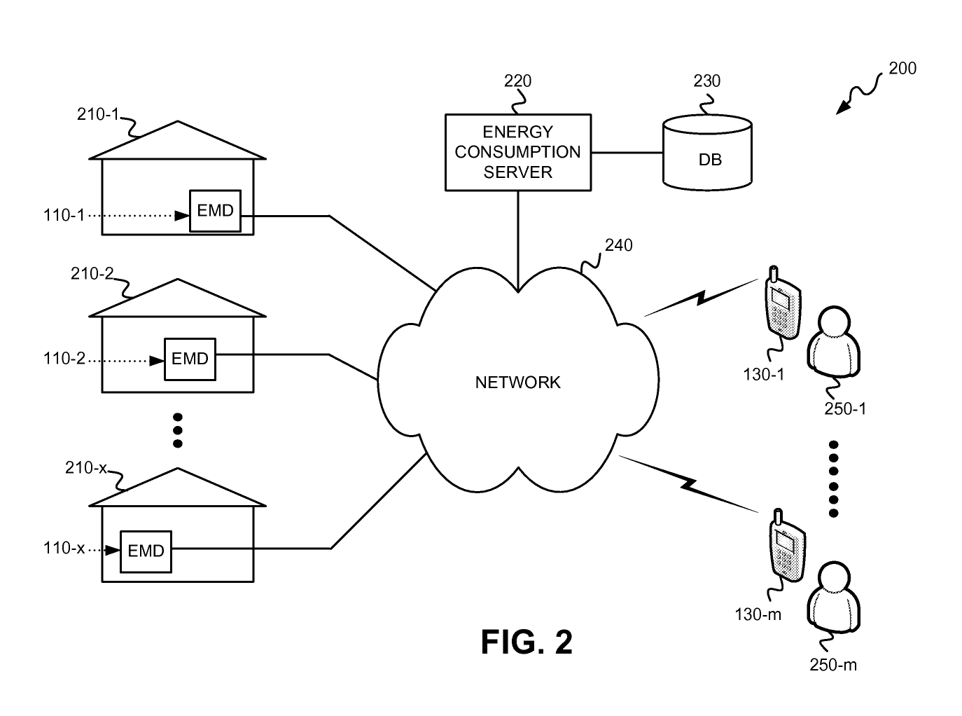

FIG. 2 illustrates an exemplary network environment 200 in which energy management devices 110 resident at households or businesses may operate to monitor the energy consumed by devices at the households or businesses. Network environment 200 may include multiple households/businesses 210-1 through 210-x (generically referred to herein as a “household/business 210”), with each including a respective one of EMDs 110-1 through 110-x, an energy consumption server 220, an energy consumption database (db) 230, multiple client devices 130-1 through 130-m, and a network 240. Users 250-1 through 250-m may use respective ones of client devices 130-1 through 130-m.

Each household/business 210 may include an EMD 110 and corresponding devices being monitored (not shown in FIG. 2) by EMD 110. Each EMD 110 may connect to network 240 for, for example, receiving data associated with energy consumption limits from a client device 130 and for sending energy consumption alerts to client device(s) 130.

Energy consumption server 220 may include a server or computing device that receives energy consumption reports, and energy consumption alerts, associated with specific devices from EMDs 110-1 through 110-x. Energy consumption server 220 may maintain a log of the energy consumption reports and energy consumption alerts in database (db) 230 for future retrieval and/or analysis.

Network 240 may include one or more networks of various types. For example, network 240 may include a cable network (e.g., an optical cable network), a wireless satellite network, a wireless public land mobile network (PLMN) (e.g., a Code Division Multiple Access (CDMA) 2000 PLMN, a Global System for Mobile Communications (GSM) PLMN, a Long Term Evolution (LTE) PLMN and/or other types of PLMNs), a telecommunications network (e.g., a Public Switched Telephone Network (PSTN)), a local area network (LAN), a wide area network (WAN), a metropolitan area network (MAN), an intranet, and/or the Internet.

The configuration of network components of network environment 200 illustrated in FIG. 2 is for illustrative purposes only. Other configurations may be implemented. Therefore, network environment 200 may include additional, fewer and/or different components than those depicted in FIG. 2.

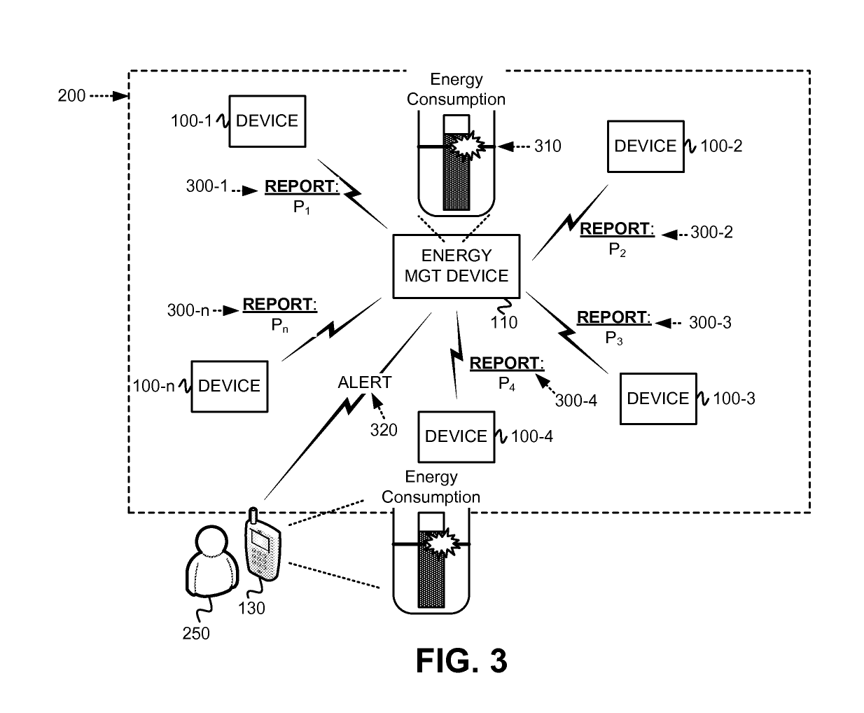

FIG. 3 is a diagram that depicts an example of a household/business 200, and the communication of energy consumption reports and alerts from devices 100 to energy management device 110 and/or client device 130. As shown, household/business 200 may include multiple devices 100-1 through 100-n and an energy management device 110. Each of devices 100-1 through 100-n may transmit respective energy consumption reports 300-1 through 300-n (generically referred to as “energy consumption report 300” herein) to energy management device 110. Upon receipt of an energy consumption report from a device 100, energy management device 110 may compare the energy consumption of device 100 with a user-specified per-device energy consumption limit 310 and, if the energy consumption exceeds energy consumption limit 310, then energy management device 110 may send an energy consumption alert 320 to client device 130 used by user 250. In some implementations, upon receipt of energy consumption alert 320, user 250, via client device 130, may instruct energy management device 110 to command device 100 to turn its power off, or to perform a graduated turn down. Alternatively, client device 130 and/or energy management device 110 may automatically reduce power consumption based on pre-set criteria (e.g., reduce consumption by increments until usage is within limits).

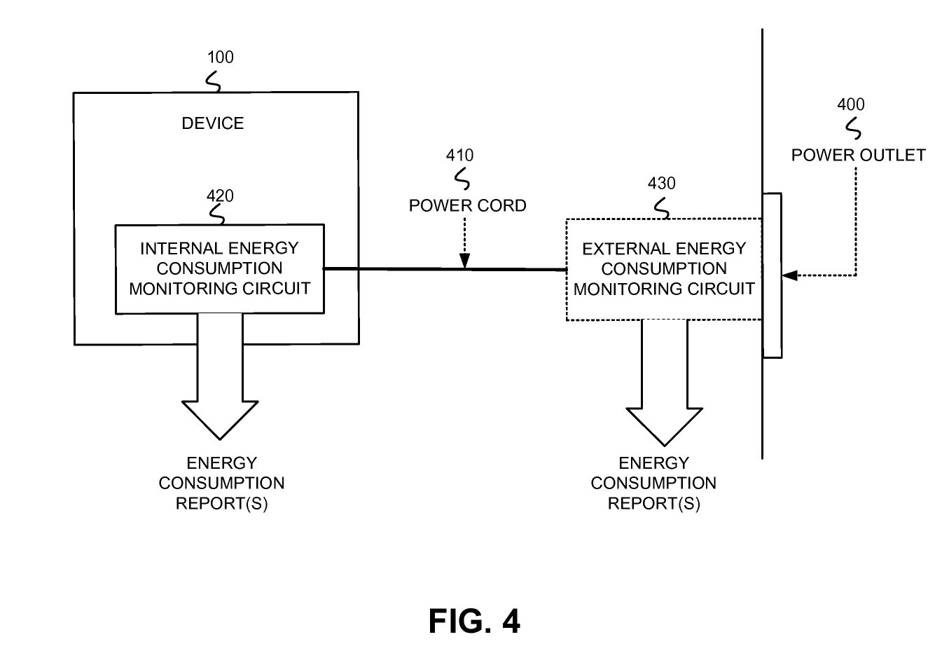

FIG. 4 depicts examples of energy consumption monitoring circuits that may used to measure energy consumption at device 100. As shown, device 100 may plug into a power outlet 400, which, in turn, may supply power to device 100 via a power cord 410. In one implementation, an internal energy consumption monitoring circuit 420, within device 100, may monitor the consumption of energy by the circuitry of device 100. In another implementation, an external energy consumption monitoring circuit 430 may monitor the consumption of energy by the circuitry of device 100. Internal energy consumption monitoring circuit 420 or external energy consumption monitoring 430 circuit may, either alone or in conjunction with other components (not shown), generate energy consumption reports for transmission to energy management device 110. The energy consumption reports may be transmitted upon the occurrence of a specific triggering event (e.g., energy consumption reaching a certain level), or may be transmitted at periodic intervals.

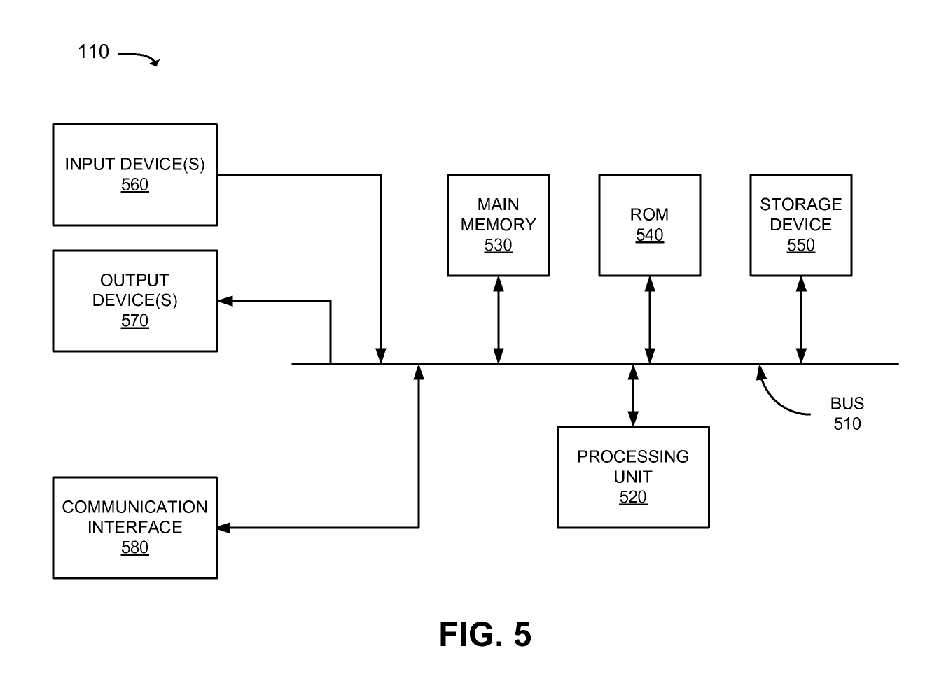

FIG. 5 is a diagram that depicts exemplary components of energy management device 110. Energy consumption server 220 and client device 130 may be similarly configured. Energy management device 110 may include a bus 510, a processing unit 520, a main memory 530, a read only memory (ROM) 540, a storage device 550, an input device(s) 560, an output device(s) 570, and a communication interface(s) 580. Bus 510 may include a path that permits communication among the elements of energy management device 110.

Processing unit 520 may include one or more processors or microprocessors, or processing logic, which may interpret and execute instructions. Main memory 530 may include a random access memory (RAM) or another type of dynamic storage device that may store information and instructions for execution by processing unit 520. ROM 540 may include a ROM device or another type of static storage device that may store static information and instructions for use by processing unit 520. Storage device 550 may include a magnetic and/or optical recording medium.

Input device 560 may include one or more mechanisms that permit an operator to input information to energy management device 110, such as, for example, a keypad or a keyboard, a display with a touch sensitive panel, voice recognition and/or biometric mechanisms, etc. Output device 570 may include one or more mechanisms that output information to the operator, including a display, a speaker, etc. Communication interface(s) 580 may include a transceiver that enables energy management device 110 to communicate with other devices and/or systems. For example, communication interface(s) 580 may include wired or wireless transceivers for communicating via network 240.

The configuration of components of energy management device 110 illustrated in FIG. 5 is for illustrative purposes only. Other configurations may be implemented. Therefore, energy management device 110 may include additional, fewer and/or different components than those depicted in FIG. 5. For example, in some implementations, energy management device 110 may include a set-top box (STB) for use in a cable network (e.g., optical fiber or satellite network). In such an implementation, the STB may include tuners, demodulators, demultiplexers, decoders and other components not depicted in FIG. 5. Client device 130 may execute a software application stored in memory 530 to set energy consumption limits of, and otherwise to control/monitor, the energy consumption of devices 100-1 through 100-n.

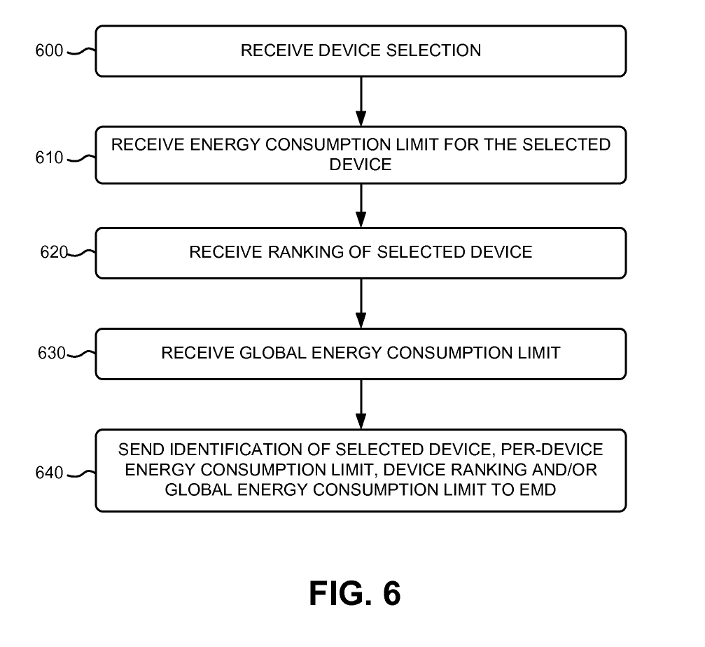

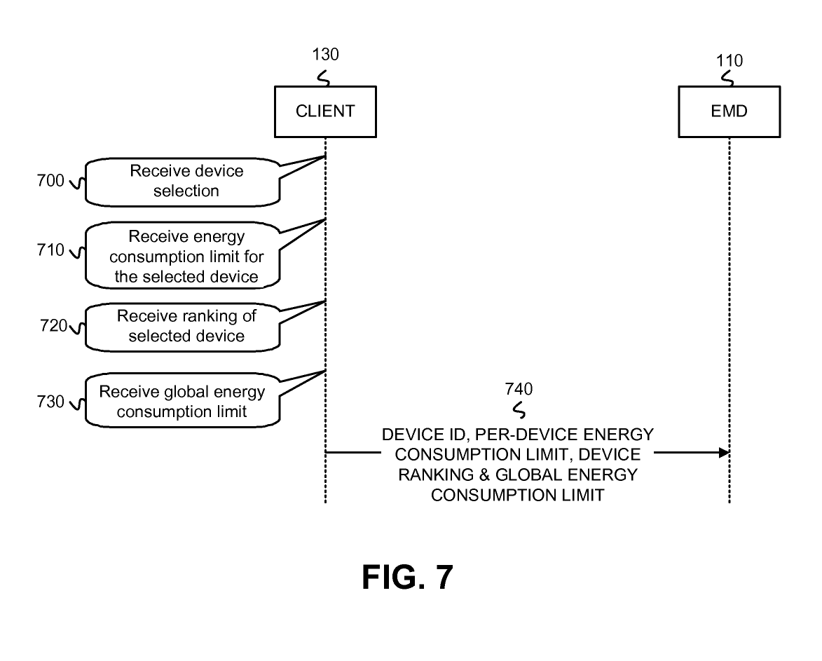

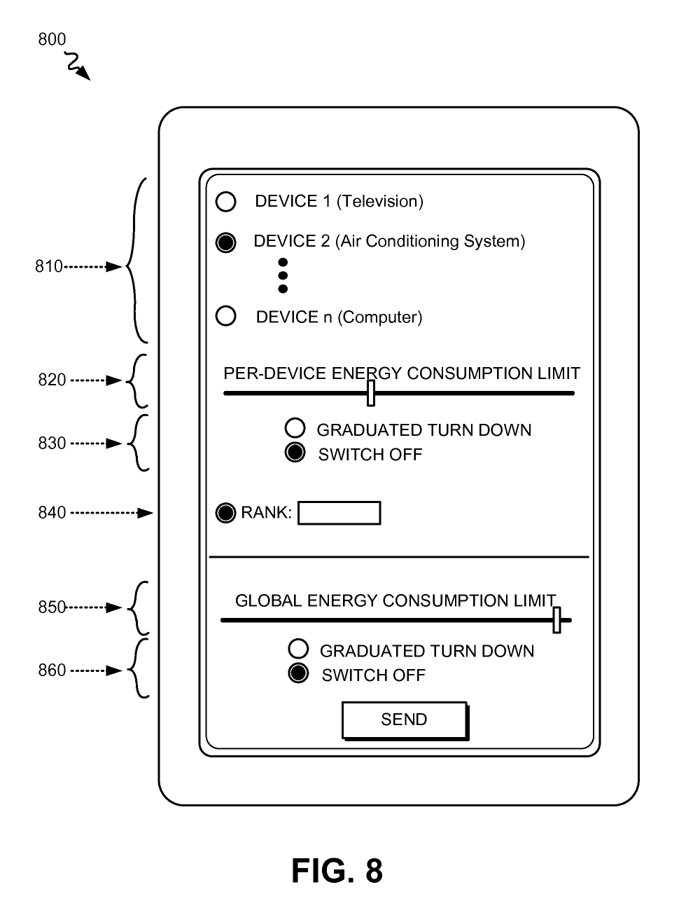

FIG. 6 is a flow diagram that illustrates an exemplary process for providing user-specified per-device energy consumption limits to energy management device 110 for use in controlling the energy consumption of devices 100-1 through 100-n. The exemplary process of FIG. 6 may be implemented by client device 130. The exemplary process of FIG. 6 is described below with reference to the exemplary messaging diagram of FIG. 7 and the exemplary user interface of FIG. 8.

The exemplary process may include receiving a device selection (block 600). A user 250 may enter, via a user interface implemented by client device 130, a selection of a device from multiple devices 100-1 through 100-n at household/business 200. In the diagram of FIG. 7, client device 130 is depicted as receiving 700 a selection of a device. The exemplary user interface 800 shown in FIG. 8 enables user 250 to select from a list 810 of devices 100-1 through 100-n at a specific household/business 200. For example, FIG. 8 depicts “device 2” being selected by the user via the user interface.

An energy consumption limit for the selected device may be received (block 610). User 250 may enter, via the user interface at client device 130, an energy consumption limit for the selected device. In the diagram of FIG. 7, client device 130 is depicted as receiving 710 an energy consumption limit for the selected device. As further shown in the exemplary user interface of FIG. 8, user 250 may enter a per-device energy consumption limit for the device selected from list 810. In the exemplary user interface of FIG. 8, the per-device energy consumption limit for the selected device may be entered via a “slider” input 820, where user 250 may “move” the slider bar to an appropriate energy consumption limit. The slider bar may specify units, such as, for example, temperature for an air conditioning system or kW used. As further shown in FIG. 8, user 250 may enter a selection 830 to either perform a “graduated turn down” of the selected device, or to “turn off” the selected device, when the energy consumption limit is exceeded. Selection of the “graduated turn down” of the selected device may cause the device to step down to a lower energy consuming state when the energy consumption limit is exceeded (e.g., a sleep mode, or a power down of certain components of the device). For example, in the case of a heating system, a graduated turn down may lower the set point temperature for the heating system by one degree increments. As another example, in the case of an air conditioning system, a graduated turn down may raise the set point temperature for the air conditioning system by one degree increments. Selection of the “turn off” of the selected device may cause the device to completely turn off when the energy consumption limit is exceeded.

A ranking of the selected device may be received (block 620). User 250 may enter, via the user interface at client device 130, a ranking associated with the device selected in block 600. In the diagram of FIG. 7, client device 130 is depicted as receiving 720 the ranking of the selected device. As further shown in the exemplary user interface of FIG. 8, user 250 may select and enter a ranking 840 for the device selected from list 810. The entered ranking 840 may be used by energy management device 110 to identify whether the device selected from list 810 should be turned off, or turned down in a graduated fashion, based, for example, on when the global energy consumption limit of block 630 is exceeded. For example, a device ranked first will be the first device for which energy consumption will be changed based on an energy limit being exceeded, followed by a device ranked second, and so on with lower ranked devices.

A global energy consumption limit may be received (block 630). User 250 may enter, via the user interface at client device 130, a global energy consumption limit associated with devices 100-1 through 100-n of household/business 200. The global energy consumption limit may be used, for example, to determine a maximum total amount of energy that all of devices 100-1 through 100-n, or some subset of devices 100-1 through 100-n, may consume before one or more of devices 100-1 through 100-n may be turned off or turned down in a graduated fashion.

User 250 may enter, via the user interface at client device 130, the global energy consumption limit associated with devices 100-1 through 100-n. In the diagram of FIG. 7, client device 130 is depicted as receiving 730 a global energy consumption limit. In the exemplary user interface of FIG. 8, the global energy consumption limit may be entered via a “slider” input 850, where user 250 may “move” the slider bar to an appropriate global energy consumption limit for devices 100-1 through 100-n. The slider bar may specify units, such as, for example, kW, kWhr. The slider bar may additionally specify costs per period of time correlated to actual energy usage rates to allow user to know the energy consumption cost savings. As further shown in FIG. 8, user 250 may enter a selection 860 to perform either a “graduated turn down” of one or more devices 100-1 through 100-n, or to “turn off” one or more of devices 100-1 through 100-n, when the global energy consumption limit is exceeded. Selection of one or more devices 100-1 through 100-n to “turn off,” or to “turn down” in a graduated fashion, may be based on device rankings 840 entered at block 620. For example, devices with a low ranking will be “turned down” or “turned off” prior to devices having a higher ranking.

Client device 130 may send an identification of the selected device, the per-device energy consumption limit, the device ranking and/or the global energy consumption limit to energy management device 110 (block 640). In the diagram of FIG. 7, client device 130 is depicted as sending a message 740 that includes a device identifier, a per-device energy consumption limit, a device ranking and a global energy consumption limit to energy management device 110.

The exemplary process of FIG. 6 has been described as being implemented by client device 130. However, in some implementations, the exemplary process of FIG. 6 may be implemented by energy management device 110, with block 640 being omitted from the process, and with blocks 600 through 630 being implemented via a user interface at energy management device 110.

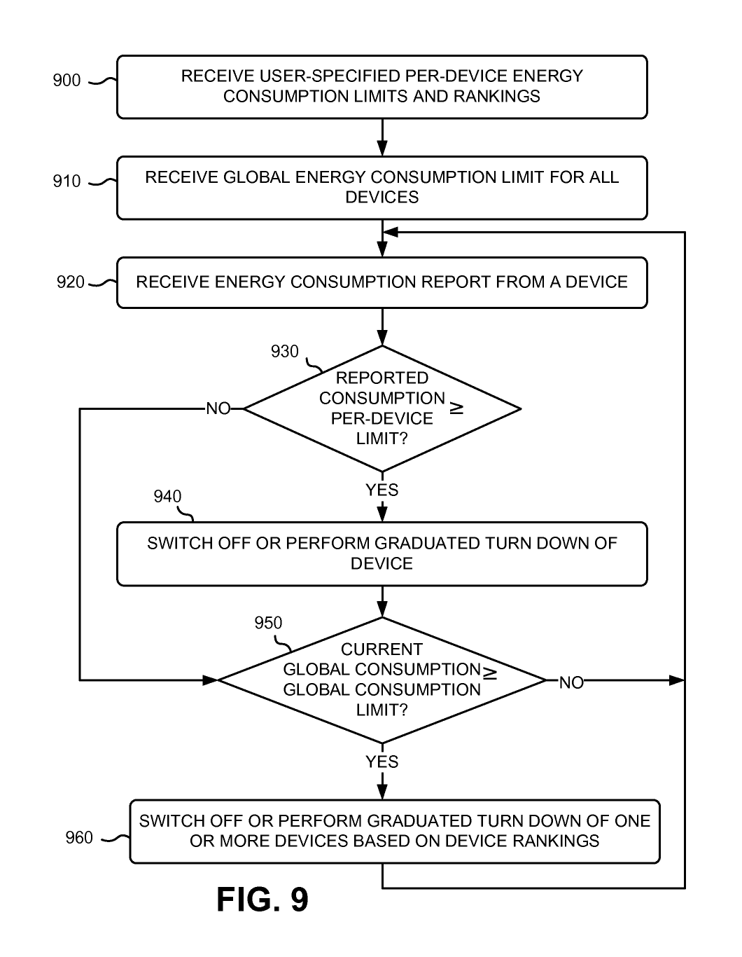

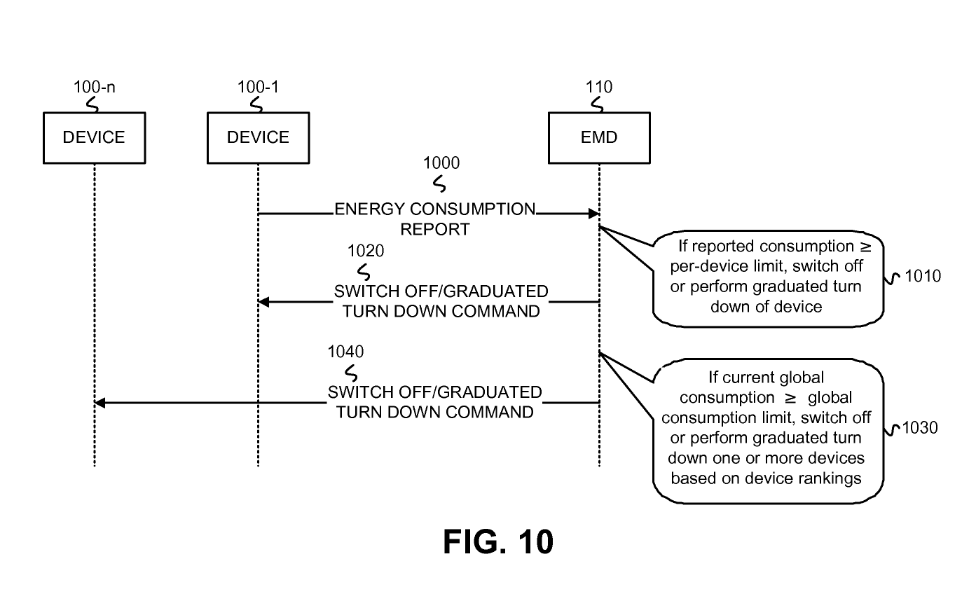

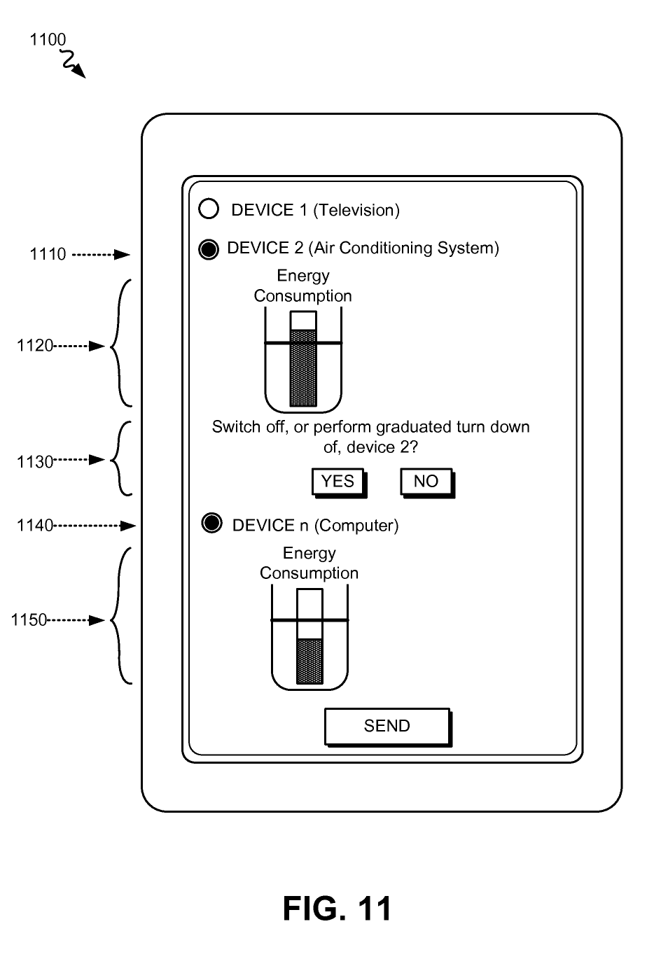

FIG. 9 is a flow diagram that illustrates an exemplary process for controlling a power down state of devices 100-1 through 100-n based on energy consumption reports received from devices 100-1 through 100-n and based on user-specified energy consumption limits. The exemplary process of FIG. 9 may be implemented by energy management device 110. The exemplary process of FIG. 9 is described below with reference to the exemplary messaging diagram of FIG. 10 and the exemplary user interface of FIG. 11.

The exemplary process may include receiving user-specified per-device energy consumption limits and rankings (block 900). The user-specified per-device energy consumption limits and rankings may be received based on their provision by user(s) 250 in blocks 610 and 620 of FIG. 6. A global energy consumption limit may be received for all devices 100-1 through 100-n (block 910). The global energy consumption limit may be received by user(s) 250 via block 630 of FIG. 6. An energy consumption report may be received from a device 100 (block 920). Each of devices 100-1 through 100-n may transmit an energy consumption report to energy management device 110. For example, FIG. 10 depicts device 100-1 transmitting energy consumption report 1000 to energy management device 110.

Energy management device 110 may determine if the reported energy consumption is greater than or equal to the per-device energy consumption limit for the device from which the report was received (block 930). If not (NO—block 930), then the exemplary process may continue at block 950 below. If the reported energy consumption is determined to be greater than or equal to the per-device energy consumption limit for device 100 (YES—block 930), then energy management device 110 may send a command to device 100 to switch off, or to perform a graduated turn down (block 940). The exemplary messaging diagram of FIG. 10 depicts energy management device 110 determining 1010, if the energy consumption reported in energy consumption report 1000 is greater than or equal to the per-device energy consumption limit for device 100-1, whether to switch off or perform a graduated turn down of device 100-1. FIG. 10 further shows energy management device 110 sending a message 1020 to device 110-1 that includes a command to switch off or to perform a graduated turn down of device 110-1. In one implementation, the exemplary user interface 1100 depicted in FIG. 11 may be used by user 250 to manually select the turn off or turn down of a device(s) of devices 100-1 through 100-n. For example, as shown in FIG. 11, user 250 may select “device 2” 1110 and “device n” 1140 of multiple devices and, when an energy consumption limit for “device 2” is exceeded (but the energy consumption limit for “device n” is not exceeded), user interface 1100 may display the energy consumption 1120 of “device 2” via client device 130. User interface 1100 may present an option 1130 for user 250 to manually select whether to switch off, or perform a graduated turn down, of “device 2.” User interface 1100 may graphically show the energy consumption limit for a device and the amount that a device's actual energy consumption is over/under the energy consumption limit.

Energy management device 110 may determine if the current global energy consumption, that takes into account the energy consumption report received in block 920, is greater than or equal to the global energy consumption limit received in block 910 (block 950). If not (NO—block 950), then the exemplary process may return to block 920 with the receipt of another energy consumption report. If the current global energy consumption is greater than or equal to the global energy consumption limit (YES—block 950), then energy management device 110 may command one or more of devices 100-1 through 100-n to switch off, or to perform a graduated turn down, based on rankings associated with devices 100-1 through 100-n. The exemplary messaging diagram of FIG. 10 depicts energy management device 110 determining 1030, if the global energy consumption which includes the energy consumption reported in energy consumption report 1000 is greater than or equal to the global energy consumption limit for devices 100-1 through 100-n, whether to switch off or perform a graduated turn down of one or more of devices 100-1 through 100-n. Selection of the specific ones of devices 100-1 through 100-n to turn off or to turn down may be based on rankings associated with each of devices 100-1 through 100-n, or based on other factors. FIG. 10 further shows energy management device 110 sending a message 1040 to device 110-n that includes a command to switch off, or to perform a graduated turn down of, device 110-n.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 6 and 9, the order of the blocks may be varied in other implementations. Moreover, non-dependent blocks may be performed in parallel. As described above, a user may interact via a user interface of EMD 110 or client device 130 to reduce energy consumption. In other implementations, EMD 110 may automatically power down devices/reduce energy consumption based on user-defined rankings or other criteria (e.g., temperature outside, whether people or in the home/business, etc.). In some implementations, EMD 110 may “learn” energy pattern selections made by a user over time and may mimic these in the future to pro-actively control energy consumption.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, at an energy management device, a first user-specified energy consumption limit associated with a first device;
receiving, at the energy management device, a second user-specified energy consumption limit associated with a second device;
receiving, at the energy management device, a first energy consumption report associated with the first device;
receiving, at the energy management device, a second energy consumption report associated with the second device; and
selectively switching off, or performing a graduated reduction of power consumption of, the first or second devices based on the received first and second energy consumption reports and based on the first and second user-specified energy consumption limits.

2. The method of claim 1, wherein the first and second user-specified energy consumption limits are received from a remote client device.

3. The method of claim 2, wherein the remote client device comprises a cellular phone; a personal data assistant (PDA); or a palmtop, lap, desktop or tablet computer executing an energy management application.

4. The method of claim 1, wherein the first and second energy consumption reports include data associated with an amount of energy consumed by the first and second devices.

5. The method of claim 1, wherein the first and second devices comprise appliances resident in a household or business and wherein the energy management device connects to each of the first and second devices via a network or link.

6. The method of claim 1, further comprising:
comparing the first energy consumption report associated with the first device with the first user-specified energy consumption limit to produce a first comparison result; and
selectively switching off, or performing a graduated reduction of power consumption of, the first device based on the first comparison result.

7. The method of claim 6, further comprising:
comparing the second energy consumption report associated with the second device with the second user-specified energy consumption limit to produce a second comparison result; and
selectively switching off, or performing a graduated reduction of power consumption of, the second device based on the second comparison result.

8. The method of claim 1, wherein receiving an energy consumption report associated with each of the first and second devices comprises:
receiving the energy consumption report from each of the first and second devices or from energy consumption monitoring circuits external to each of the first and second devices.

9. An energy management device, comprising:
a communication interface coupled to a network and configured to:
receive a first user-specified energy consumption value associated with a first device, wherein the first device comprises an appliance resident in a household or business,
receive, via the network or a link, first energy consumption information associated with the first device, and
a processing unit configured to selectively switch off, or perform a graduated reduction of power consumption of, the first device based on the received first energy consumption information and the first user-specified energy consumption value.

10. The energy management device of claim 9, wherein the communication interface is further configured to:
receive a second user-specified energy consumption value associated with a second device,
receive second energy consumption information associated with the second device, and
where the processing unit is further configured to selectively switch off, or perform a graduated reduction of power consumption of, the second device based on the received second energy consumption information and the second user-specified energy consumption value.

11. The energy management device of claim 9, wherein the first user-specified energy consumption value is received via a user interface at the energy management device or from a remote client device.

12. The energy management device of claim 9, wherein the first energy consumption information is received from the first device or from an energy consumption monitoring circuit associated with the first device.

13. The energy management device of claim 9, wherein the processing unit is configured to:
compare the first energy consumption information with the first user-specified energy consumption value to produce a first comparison result; and
selectively switch off, or perform the graduated reduction of power consumption of, the first device based on the first comparison result.

14. A method, comprising:
receiving, at a client device, a selection of a first device from a list of a plurality of devices, wherein the plurality of devices comprise appliances resident at a household or business;
receiving, at the client device, a first user-specified energy consumption limit for the selected first device; and
sending, from the client device via a network, an identification of the selected first device and the first user-specified energy consumption limit to an energy management device associated with the household or business, wherein the energy management device selectively controls the selected first device based on the first user-specified energy consumption limit.

15. The method of claim 14, further comprising:
receiving, at the client device, a selection of a second device from the list of the plurality of devices;
receiving, at the client device, a second user-specified energy consumption limit for the selected second device; and
sending, from the client device via a network, an identification of the selected second device and the second user-specified energy consumption limit to the energy management device, wherein the energy management device selectively controls the selected second device based on the second user-specified energy consumption limit.

16. The method of claim 14, wherein the client device comprises a cellular phone; a Personal data assistant (PDA); or a palmtop, lap, desktop or tablet computer.

17. A client device, comprising:
a user interface configured to:
receive a selection of a first device from a list of a plurality of devices, wherein the plurality of devices comprise appliances resident at a household or business,
receive a first user-specified energy consumption value for the selected first device, and
a communication interface configured to send, from the client device via a network, an identification of the selected first device and the first user-specified energy consumption value to an energy management device associated with the household or business,
wherein the energy management device selectively controls the selected first device based on the first user-specified energy consumption value.

18. The client device of claim 17, wherein the user interface is further configured to:
receive a selection of a second device from the list of the plurality of devices;
receive a second user-specified energy consumption value for the selected second device; and
wherein the communication interface is further configured to send, from the client device via a network, an identification of the selected second device and the second user-specified energy consumption value to the energy management device, wherein the energy management device selectively controls the selected second device based on the second user-specified energy consumption value.

19. The client device of claim 17, wherein the client device comprises a cellular phone; a personal data assistant (PDA); or a palmtop, lap, desktop or tablet computer.

20. The client device of claim 17, wherein the communication interface is further configured to receive an energy consumption alert from the energy management device and wherein the user interface is further configured to display the energy consumption alert.
